(19) United States
(12) Patent Application Publication
(10) Pub. No.: US 2007/0297073 A1
(43) Pub. Date: Dec. 27, 2007

(54) 3D ENHANCEMENT SYSTEM FOR MONITOR

(76) Inventors: John Braithwaite, Dalserf (GB); Eamonn Ansbro, Boyle (IE)

Correspondence Address: Paul B. Overhauser;Overhauser Law Offices, LLC, Suite 300, 737 W. Green Meadows Drive, Greenfield, IN, 46140, US

(21) Appl. No.: 11/426,057

(22) Filed: Jun. 23, 2006

(51) Int. Cl. G02B 3/08

(52) U.S. Cl. 359/742

(57) ABSTRACT

System for producing a simulated 3D image from a 2D image having a fresnel lens with two planes of curvature transverse to each other so as to create a substantially convex. The fresnel lens may be flexible and positioned within a mount configured with adjustable tensioning members so as to tune the optical characteristics of the fresnel lens so as to optimise production of the simulated 3D image.

### FIELD OF THE INVENTION

The present invention relates to apparatus and method for producing an image having enhanced depth or a simulated 3D effect using a fresnel lens.

### BACKGROUND TO THE INVENTION

Three-dimensional graphics and imaging technology has experienced explosive growth in recent years. A significant contribution to this growth has been its adaptability to a wide spectrum of applications, not to mention the numerous advantages it provides over 2D. Currently, 3D graphics technology is used extensively in design-related applications, such as architecture and engineering. It is also used in scientific investigations, such as the recreation of airplane crash disasters, and, in recreational-type activities, such as computer games, to name a few. The sophistication of these graphics afford an individual a realistic perspective of how various objects appear (and perhaps even dynamically inter-relate) in a virtual setting, thus providing an indispensable tool to a user of such graphics.

Currently, one significant problem encountered with 3D graphics is the user's inability to properly interpret the relative depths of objects in 3D scenes (i.e., depth perception). This is primarily caused by the 3D graphics (whether generated by computer modeling or by photos or real objects) being projected onto a flat, two-dimensional computer screen, which severely limits the user's perception of this third dimension of 3D. As a result, the user cannot fully realize, and, thus appreciate, the depth of a 3D scene that makes these graphics more realistic or life-like.

In the real world, depth perception is typically facilitated by movements that are sub-consciously performed by an individual, whether it is a subtle shift of the individual's body, head, or eyes. Such movements by the individual are commonly known as relative motion. However, although these subtle movements by the individual work in the real world for providing a better understanding of depth, such movements will not facilitate depth perception on conventional computer screens because the screens themselves are two-dimensional, and the light projecting therefrom reaches the right and left eyes at the same angle.

In an attempt to overcome this difficulty in perceiving depth, a computer user will often change the orientation of a 3D graphics scene (e.g., by navigation) to gain the benefits of relative motion as experienced in the real world. However, this action inconveniences the user by placing the burden on him or her to provide such motion, especially if the user desires to remain static in the 3D scene to study a particular object. Moreover, while the user is trying to better interpret the 3D scene by engaging in navigation, he or she is distracted by concentrating more on the navigation process itself. That is, navigation requires the user to perform conscious acts (via a user-input device, for example) to provide this movement and is not sub-consciously performed, as relative motion is performed in the real world.

Typically, 3D graphics applications are designed with a variety of features to attempt to improve 3D simulation on a flat computer screen. These features include occlusion, shading, fog, size gradients, among others. However, although these features may improve depth perception in 3D scenes to some degree, they do not provide the user with a complete concept of depth in a quantitative manner, which is typically satisfied by relative motion in the real world.

A good form of relative motion is the full duplication of the natural vision environment by providing a true 3D display. Such a display would permit the user to perform his or her natural psychomotor abilities (i.e., body, head, and eye movement) to obtain the relative motion necessary to properly interpret a 3D scene. However, while these displays have been prototyped, their widespread use in the near future is unlikely. Furthermore, if and when these displays do become available, their cost is expected to be quite lofty, thus placing these displays out of the general public's reach.

The present invention is directed to overcoming, or at least reducing the effects of, one or more of the problems set forth above.

### SUMMARY OF THE INVENTION

The inventors provide a system for producing a simulated 3D image from a 2D image comprising a fresnel lens, the fresnel lens having a first plane of curvature positioned substantially transverse to a second plane of curvature so as to create a substantially convex lens. The fresnel lens may be flexible and positioned within a mount configured with adjustable tensioning members so as to tune the optical characteristics of the fresnel lens so as to optimise production of the simulated 3D image.

The invention comprises a system for enhancing the image from a projected visual display comprising a fresnel lens having a smooth (non-lensed) side and a lensed side. The lensed side is positioned toward the projected visual display. The fresnel lens is curved along two transverse axes or planes (e.g., a horizontal axis and a vertical axis, or two diagonal axes), and it may be angularly disposed along a vertical axis with respect to the projected visual display.

The present invention relates to opto-mechanical devices for use on video display units or monitors displaying 2½ D information, such as those typically employed in the fields of expert visualization data (e.g. medical imaging), advertising, display, home computing, and computer games. It relates to its use as both an image display and/or as an image projection system.

By tunably curving the fresnel lens in at least two planes to form a convex type configuration, that is both the smooth surface and the lensed surface of the fresnel lens are curved, an opto-mechanical system is provided which allows a user to experience enhanced depth of the image, that is a simulated 3D effect being generated from a 2D image source. According to specific implementations of the present invention the image source may comprise a real object or an image (e. g. a non-self illuminating image) or a projected image produced from an image source (e. g. any form of image projection system comprising self illumination such as a computer monitor or cinematic display), or the reflection of an image or object produced by some other source including those mentioned above.

By the relative positioning of the fresnel lens between the viewer and the image with the lensed surface receiving incident light waves from the 2D image two distinct advantages are realised in the generation of the simulated 3D image, these being:
The reduction of chromatic (color) abberrations/distortions; and
Magnification, which is inherent in the system, is kept to a minimum, excess magnification being disadvantageous to resolution in the direct or projected viewing of a simulated 3D image.

So as to create an image viewed by a user having enhanced depth (e.g. a simulated 3D image) the inventors use a fresnel lens comprising a two-axis or two-plane curvature (involving two preferential axes/planes of curvature positioned transverse to one another) where the edge or edges (or the corners, e.g.) of the fresnel lens curve back towards the 2D image so that the central area of the fresnel lens is closest to the viewer (i. e. convex to the viewer) according to one specific implementation. Such a system creates an enhanced depth and the associated 3D effect while minimizing distortion. Accordingly, the optical system of the present invention does not require significant consideration of the alignment of the fresnel lens (e. g. tilting) to eliminate distortion.

According to a specific implementations of the present invention one or a plurality of fresnel lenses may be employed to effect the image (e. g. real image or generated image) such that the resulting image generated by the fresnel lens is subsequently reflected from a reflective surface. The resulting reflective image may then be viewed by a user as having enhanced depth (simulated 3D effect). Where a plurality of image-fresnel lens units are employed the resulting effected images may be reflected from a reflective surface to produce a resulting composite image having enhanced depth.

According to a first aspect of the present invention is provided a system for producing a simulated 3D image from a 2D image, said system comprising a fresnel lens having at least two axes of curvature, said at least two axes of curvature being transverse to one another; wherein said fresnel lens is orientated relative to said 2D image to produce a simulated 3D image having enhanced depth.

Preferably, wherein a lensed surface of said fresnel lens is orientated relative to said visual display wherein light waves from said 2D image are incident at said lensed surface of said fresnel lens, the refracted light waves being received at a viewer as an image of said 2D image having enhanced depth.

Preferably, wherein a substantially central area of said fresnel lens is a further distance from said 2D image than at least one side edge of said fresnel lens.

Preferably, wherein light waves refracted by said fresnel lens are received by a left and right eye of a viewer at slightly varied angles.

Preferably, wherein said fresnel lens is flexible, said system further comprising: means for adjusting an amount of curvature of said fresnel lens.

Preferably, wherein a curvature of said fresnel lens is configured to refract light waves resulting from said 2D image to create depth perception of said 2D image when said 2D is image is viewed through said fresnel lens.

Preferably, said system further comprises an anti-reflective coating (e.g., magnesium fluoride) on at least one surface of said fresnel lens.

Preferably, the system further comprises an anti-reflective screen positioned to receive a visual image projected by said fresnel lens.

Preferably wherein said fresnel lens is flexible, said system further comprising a frame configured for mounting said fresnel lens; and a plurality of adjustable engagers being positively adjustable through said frame, each engager of said plurality of engagers being configured for an independent engaging of a portion of an outer edge of said fresnel lens; wherein an engaging of said outer edge by each said engager is adjustable to provide a flexing of said fresnel lens and a change in optical properties of said fresnel lens.

Preferably, the system further comprises a reflective surface configured for reflecting light waves received from said fresnel lens to a viewer.

Preferably, wherein said reflective surface is a flat mirror.

Preferably, wherein said reflective surface is a curved mirror.

Preferably, wherein said reflective surface is a spherically curved mirror configured for producing an image of said 2D image comprising enhanced depth.

Preferably, wherein said reflective surface is an oblate spheroid mirror configured for producing an image of said 2D image comprising enhanced depth.

Preferably, the system further comprises a plurality of fresnel lenses being configured for refracting light waves received from a plurality of 2D images; and means for directing said refracted light waves from said plurality of said fresnel lenses onto said reflective surface; wherein said reflective surface is configured to generate a composite simulated 3D image of said plurality of 2D images.

Preferably, the system further comprises an additional fresnel lens being positioned adjacent to said reflective surface wherein light waves from at least one 2D image are refracted by at least a first and second fresnel lens prior to reflection by said reflective surface.

Preferably, wherein said reflected light waves, reflected from said reflective surface, are refracted by at least one fresnel lens.

According to a second aspect of the present invention is provided a method of producing a simulated 3D image of a real object or a substantially 2D image comprising refracting light waves from an object or a 2D image through a curved fresnel lens having a smooth surface and a lensed surface; wherein said fresnel lens is configured to generate a simulated 3D image of said object or said 2D image.

Preferably, wherein said method is configured to generate a simulated 3D image from a non-self-illuminating 2D image.

Preferably, wherein said method is configured for generating a simulated 3D image from a self-illuminating 2D image, said 2D image comprising any one or a combination of the following set of:
a non-emissive display, in particular a liquid crystal display;
a computer monitor display;
a cinematic display;
a plasma screen; or
a reflection of an image originating from an image source.

Preferably, wherein said fresnel lens is curved in two planes.

Preferably, wherein adjusting a curvature of said fresnel lens so as to tune at least one optical characteristic of said fresnel lens.

Preferably, wherein a central region of said fresnel lens is positioned at a greater distance from said 2D image than a perimeter or portion of a perimeter of said fresnel lens.

Preferably, the method further comprises adjustably mounting said fresnel lens within a frame using a plurality of adjustable tensioning engagers; adjusting each engager so as to engage a portion of an outer edge or corner of said fresnel lens; adjusting the curvature of said fresnel lens by adjustment of at least one engager of said plurality of engagers; wherein at least one optical characteristic of said fresnel lens is altered.

Preferably, the method further comprises reflecting light waves received from said fresnel lens via a reflective surface to a viewer.

Preferably, the method further comprises a plurality of curved fresnel lenses positioned adjacent a plurality of 2D images, each fresnel lens of said plurality of curved fresnel lenses comprising a smooth surface and a lensed surface, said lensed surface being positioned adjacent and facing each 2D image of said plurality of 2D images; reflecting light waves received from said curved fresnel lenses at a reflective surface; and projecting the reflected light waves from said reflective surface to a viewer

Preferably, the method further comprises positioning an additional fresnel lens adjacent said reflective surface; wherein light waves pass through said additional fresnel lens prior to and/or after reflection at said reflective surface.

Preferably, wherein said reflective surface is a substantially flat surface.

Preferably, wherein said reflective surface is a curved reflective surface.

According to a third aspect of the present invention is provided a system for enhancing the image from a projected visual display comprising a fresnel lens having a flat side and a lensed side; the lensed side facing the projected visual display; the fresnel lens having side edges and being curved along two preferential axes that are transverse to one another (e.g., a horizontal axis and a vertical axis, or two diagonal axes) wherein a central area of said lens is further from the projected visual display than at least one of its side edges.

Preferably, the system further comprises a structure attaching the fresnel lens to a housing containing a visual display projection system.

Preferably, wherein the fresnel lens is flexible, and further comprising means for adjusting the amount of curvature of the fresnel lens.

Preferably, the system further comprises means for adjusting the angular disposition of the fresnel lens relative to the projected visual display.

According to a fourth aspect of the present invention is provided a method of enhancing the image from a projected visual display comprising the steps of passing the projected visual display through a fresnel lens having a smooth side and a lensed side, wherein the fresnel lens is positioned so that the lensed side faces the projected display, and wherein the fresnel lens is curved along a first plane, and a second plane with respect to the projected visual display.

According to a fifth aspect of the present invention is provided a system for enhancing the image from a projected visual display comprising a fresnel lens having a non-lensed side and a lensed side the lensed side facing the projected visual display, the fresnel lens having side edges and being curved along two transverse axes or planes wherein a central area of said fresnel lens is further from the projected visual display than the corners or side edges of said fresnel lens.

Preferably, wherein a curvature of said fresnel lens is angularly disposed along a vertical axis with respect to the projected visual display.

Preferably, the system further comprises a structure attaching the fresnel lens to a housing containing a visual display projection system.

Preferably, wherein, the fresnel lens is flexible, and further comprising means for adjusting the amount of curvature of the fresnel lens.

Preferably, the system further comprises means for adjusting the angular disposition of the fresnel lens relative to the projected visual display.

According to a sixth aspect of the present invention is provided a method of enhancing an image from a projected visual display comprising the steps of passing light waves from a projected visual display through a fresnel lens having a non-lensed side and a lensed side, wherein the fresnel lens is positioned so that the lensed side faces the projected visual display, and wherein the fresnel lens is curved along two axes said axes being aligned transverse to one another.

Preferably, wherein the axes of curvature are angularly disposed along a vertical axis with respect to the projected visual display.

According to a seventh aspect of the present invention is provided a system for producing an image having enhanced depth, said system comprising a fresnel lens comprising a non-lensed surface; a lensed surface; a curvature along two transverse axes; wherein said fresnel lens is configured to refract light waves to produce an image having enhanced depth.

Preferably, wherein said non-lensed surface is positioned facing a viewer or an intermediate reflective surface, said viewer receiving said image with enhanced depth produced by said fresnel lens.

Preferably, the system further comprises at least one mirror configured for reflecting light waves to produce said image with enhanced depth.

Preferably, wherein said at least one mirror is a curved mirror or flat mirror.

Preferably, wherein said system is configured as a folded optical system wherein system further comprises a flat mirror angularly positioned (e.g., 45°) relative to a 2D image; wherein light waves from said 2D image are reflected by said flat mirror, and refracted by said fresnel lens.

Preferably, wherein said system is configured as a folded optical system wherein the system further comprises a flat mirror angularly positioned (e.g., 45°) relative to a 2D image; and a curved mirror; wherein light waves from said 2D image are reflected by said flat mirror, refracted by said fresnel lens and reflected by said curved mirror.

Preferably, wherein said system is configured as a folded optical system wherein said curved mirror is a spherically curved mirror configured for producing an image of said 2D image comprising enhanced depth.

Preferably, wherein said system is configured as a folded optical system wherein said curved mirror is an oblate spheroid mirror configured for producing an image of said 2D image comprising enhanced depth.

Preferably, wherein said system configured as a folded optical system has a second fresnel lens positioned between said curved mirror and the viewer.

According to an eighth aspect of the present invention is provided an optical system for producing a virtual 3D image from a 2D image, said system comprising: a fresnel lens comprising: a curvature in a fist plane; and a curvature in a second plane, said curvature in said second plane being substantially transverse to said curvature in said first plane; wherein said fresnel lens comprises a convex shape in a central area of said lens.

According to a ninth aspect of the present invention is provided a fresnel lens configured for producing a virtual 3D image from a 2D image comprising: a first curvature in a first plane of fresnel lens; and a second curvature in a second plane of said fresnel lens; wherein said first plane and said second plane are substantially transverse, said fresnel lens comprising a substantially convex shape in a central area of a said lens.

According to a tenth aspect of the present invention is provided a fresnel lens configured for producing an image having enhanced depth, said fresnel lens comprising: a substantially smooth surface; a lensed surface; a first curvature along a first direction of said smooth surface and said lensed surface; a second curvature along a second direction of said smooth surface and said lensed surface; wherein said first curvature and said second curvature are orientated in the same direction, substantially transverse to one another.

Preferably, wherein said fresnel lens is flexible.

Preferably, the lens further comprises a frame configured for mounting said fresnel lens; and at least one engager being positively adjustable through said frame configured to adjust an amount of curvature of said fresnel lens.

Preferably, the lens further comprises a frame configured for mounting said fresnel lens; and a plurality of engagers being positively adjustable through said frame, each engager of said plurality of engagers being configured for an independent engaging of an edge of said fresnel lens wherein an engaging of said edge by each said engager is adjustable to provide a flexing of said fresnel lens and a change in at least one optical property of said fresnel lens.

The inventors further provide a tunable optical system configured for mounting and tunably adjusting at least one optical property or a plurality of optical properties of an optical element. Such a tunable optical system provides adjustment and selective variation of the optical characteristics of the lens including specifically the light transmissive or reflective properties of the lens both as a whole and with regard to particular specific areas or regions of the lens. A system is thereby provided to offset or eliminate optical aberrations or to create a desired optical effect. Such a system may optionally be free standing and self contained or incorporated within a larger optical-mechanical device configured for creating a simulated 3D image.

According to a eleventh aspect of the present invention is provided a tunable optical system comprising a flexible optical element having an outer edge; a frame configured for mounting said optical element; a plurality of adjustable engagers being positively adjustable through said frame each engager of said plurality of engagers being configured for an independent engaging of a portion of said outer edge of said optical element; wherein an engaging of said outer edge by each engager is adjustable to provide a flexing of said optical element and a change in optical properties of said optical element.

Preferably, wherein said optical element comprises a fresnel lens for generating a simulated 3D image from a 2D image.

Preferably, wherein said fresnel lens comprises a smooth surface and a lensed surface, said fresnel lens being orientated such that said lensed surface faces said 2D image.

Preferably, wherein said frame is a rigid frame, said engagers being configured to exert a varying tensioning force on said optical element so as to alter the curvature of the optical element providing adjustment of said optical characteristics of said optical element.

Preferably, wherein each engager is configured to be screwed inward and outward relative to a central portion of said optical element.

Preferably, wherein each engager is configured for engaging directly onto an outer edge of said optical element.

Preferably, wherein each engager of said plurality of engages comprises a saddle, said saddle configured for positioning over said outer edge of said optical element.

According to a twelfth aspect of the present invention is provided a tunable optical system comprising: a flexible optical element having an outer edge or perimeter; a frame configured for mounting said optical element; at least one adjustable engager being positively adjustable through said frame, said engager being configured for engaging a portion of said outer edge or perimeter of said optical element; wherein an engaging of said outer edge or perimeter by said engager is adjustable to provide a flexing of said optical element and a change in optical properties of said optical element.

According to a thirteenth aspect of the present invention is provided an optical system comprising: a flexible optical element having an outer edge or perimeter; a frame configured for mounting said optical element; at least one engager configured for engaging a portion of said outer edge or said perimeter of said optical element; wherein said optical element is fixed in position in said frame so as to create a curvature of said optical element, said curvature comprising a curvature in a first plane and second plane substantially transverse to said first plane.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a side view of monitor having a 3D enhancement system according to the present invention, including the optional vertical angular displacement.

FIG. 2 illustrates a perspective view of the optical system showing the two-axis curvature of the Fresnel lens according to a specific implementation of the present invention.

FIG. 3 illustrates a perspective view of the optical system showing a two-axis curvature of the fresnel lens within a frame holder according to a specific implementation of the present invention.

FIG. 4 is a top sectional view of monitor having a 3D enhancement system according to a specific implementation of the present invention.

FIG. 5 is a side view of a monitor with a pivotal bracket supporting a screen framework according to a specific implementation of the present invention.

FIG. 6A is a top section view showing the engagement of the fresnel lens within a mechanism for tuning the curvature of the fresnel lens according to a specific implementation of the present invention

FIG. 6B is a rear view of a portion of the fresnel and frame in an embodiment of the present invention showing one corner of a frame holding a lens securement device, including the corner edge of the fresnel according to a specific implementation of the present invention.

FIG. 6C is a top view of a frame holding a lens securement device without the fresnel according to a specific implementation of the present invention.

FIG. 6D is an isometric top view of the corner of a frame holding a lens in a lens securement device, showing the resulting curvature of the fresnel according to a specific implementation of the present invention.

FIG. 7 is a side elevation view of a fresnel lens mounted within a screen framework supported by a base that is detachable from the monitor according to a specific implementation of the present invention.

FIG. 8 illustrates a schematic view of the optical system configured for creating simulated 3D where the generated image is reflected from a reflective surface according to a specific implementation of the present invention.

FIG. 9 illustrates a schematic view of the optical system configured for creating simulated 3D where the generated image is reflected from a reflective surface according to a specific implementation of the present invention.

FIG. 10 herein illustrates a schematic view of a further embodiment of the present invention comprising a flat mirror and curved mirror as part of a folded optical system according to a further specific implementation of the present invention.

FIG. 11 shows a front elevation view of the present invention where an optical element is held by a plurality of tensioning members according to a specific implementation of the present invention.

FIG. 12 illustrate a side perceptional view of the optical system of FIG. 11 herein.

FIG. 13 illustrates a cross-sectional view of one positively adjustable engager engaging into an outer edge of the optical element according to a specific implementation of the present invention.

FIG. 14 illustrates a cross-sectional view of a further embodiment to that of FIG. 13 herein.

FIG. 15 illustrates a front elevation view of a further embodiment of FIG. 11 herein.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

An optical system is provided comprising a fresnel lens configured for refracting light waves from a 2D image so as to produce a simulated, virtual 3D image perceived by a viewer as having enhanced depth. The fresnel lens comprises a first curvature directed along a first direction, axis or plane and a second curvature directed along a second direction, axis or plane so as to provide a curved fresnel lens forming a generally convex lens (depending upon the relative orientation of the lens) in its central area.

Where the lens shape is substantially square or rectangular the fresnel lens, according to the required curvature, may be perceived as having a central area whereby the corners and corner edges of the fresnel lens are bent back in the same direction away from the central portion. Similarly, where the fresnel lens is substantially circular the curvature is along two preferential axes so as to create a convex disc, both axes of the fresnel lens comprising identical or similar curvature. Where the fresnel lens is substantially oval the curvature is alone two preferential axes so as to create a convex disc, both axes of the fresnel lens comprising identical or similar directions of curvature, however one axis may have a greater degree of curvature than the other.

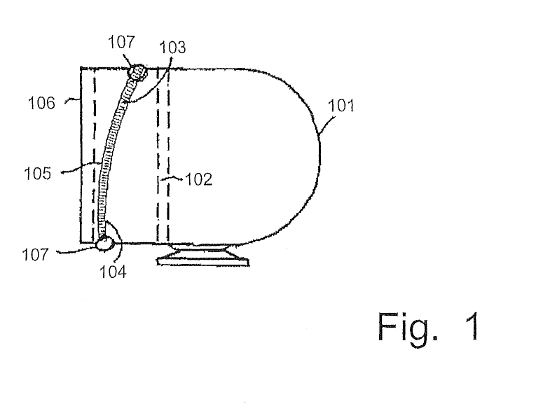

Referring to FIG. 1 herein there is shown a side elevation view of a monitor housing 101 which contains an image display device, such as a monitor. It will be appreciated that the monitor can be of any conventional variety, such as a TV, computer video tube, plasma screen, or LCD screen (transmissive or emissive). Any system for projecting an image is suitable, including self-illuminated objects. For the purpose of this description we will use the example of a monitor. The monitor surface may be either flat or curved. An image display source of any shape may be used (e.g., circular, octagonal, etc.) The monitor includes a monitor display screen 102. Spaced from monitor display screen 102 is fresnel lens 103. The lens refracts the light from monitor display screen 102. Fresnel lens 103 has two sides, flat side or smooth surface 105 and lensed or grooved side 104. Fresnel lens surfaces 104 and/or 105 may optionally be coated with an anti-reflective coating (e.g., magnesium fluoride). Anti-reflective coatings on Fresnel lens 103 are not mandatory to achieve the enhanced 3D effect, but it may provide an improved view depending on the ambient light conditions in which the invention is deployed. Fresnel lens 103 may be angularly disposed (such as a 15-25 degree angle) along a vertical axis with respect to the projected visual display from monitor display screen 102, which is believed to reduce distortion of the image projected by monitor display screen 102 depending on the application and the position of the viewer. The distance of the curved fresnel from the surface of the image source may vary, depending on the desired amount of enhanced depth/3D effect and depending on the viewing angle that is desired. Finally, anti-reflective screen 106 is positioned distal to monitor display screen 102. Anti-reflective screen 106 may be a conventional screen made of glass or plastic, such as those that achieve their anti-reflective characteristics via a vacuum deposited magnesium fluoride, a technique well-known to those skilled in the art. Anti-reflective screen 106 is not mandatory to achieve the enhanced 3D effect, but it may provide an improved view depending on the ambient light conditions in which the invention is deployed.

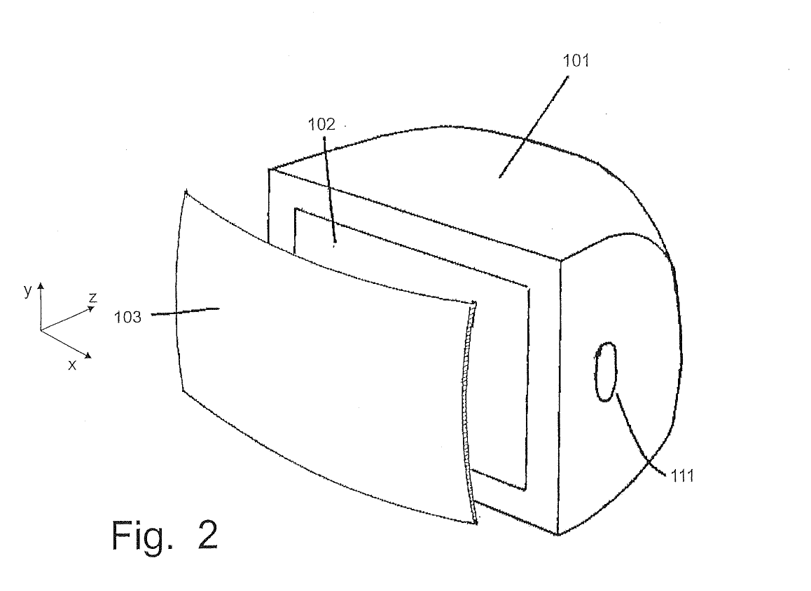

Referring to FIG. 2 herein there is illustrated a perspective view of the optical system of FIG. 1 herein illustrating curvature of fresnel lens 103. According to the specific implementation of the present invention the fresnel lens comprises a two-axis or two-plane curvature (e.g. a first axis of curvature being positioned substantially transverse to a second axis of curvature) wherein an outer edge of the fresnel lens is positioned closest to the image, the central area of the fresnel lens being closest to the viewer. As illustrated within FIG. 2 herein, the fresnel lens is curved in a first plane (the x-plane) and a second plane (the y-plane) so as to form a fresnel lens having two planes of curvature. Moreover, all four corners of the four sided fresnel lens curve back towards the 2D image such that the smooth surface of the lens appears convex to the viewer (the lensed side of the fresnel lens being concave relative to the image or monitor).

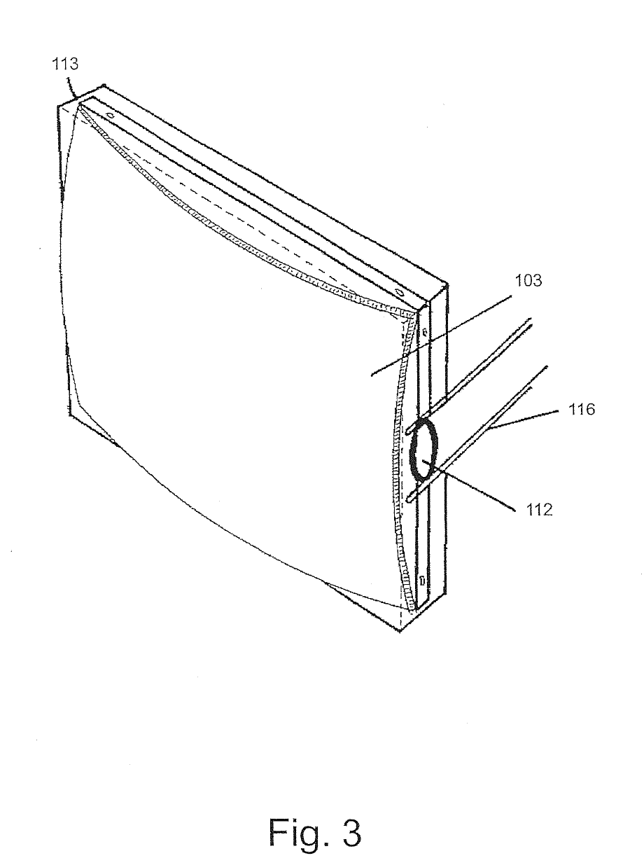

Referring to FIG. 3 herein there is illustrated a perspective view of the optical system of FIG. 2 herein further comprising bracket 116 and framework locking knob 112 configured for positioning fresnel lens 103 relative to monitor housing 101).

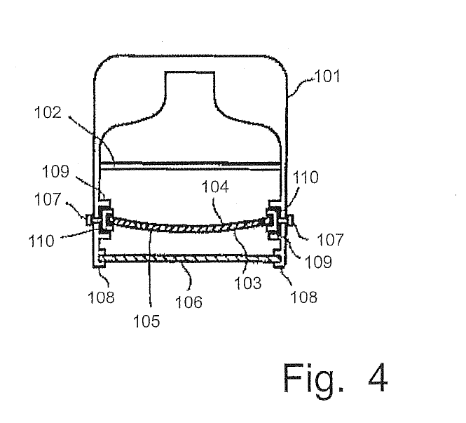

Referring to FIG. 4 herein is a top section view of monitor having a 3D enhancement system according to the present invention. From this view it will be appreciated that monitor screen 102 and anti-reflective screen 106 may have a generally flat surfaces, although a slight curvature is often used for monitor screens. In contrast, in accordance with the present invention, fresnel lens 103 is curved along two tranverse axes (e.g., both its horizontal and vertical axes, or two diagonal axes) so that its central area is further from the projected visual display than its side edges. In one embodiment, fresnel lens 103 may be a flexible 30 cm×25.5 cm fresnel lens, available from Lenses, Ltd, of London England. This particular variety is comprised of flexible plastic, allowing a curvature to be imparted to the lens. In one embodiment, the amount of the curvature is such that the width of a 30 cm lens is reduced to 29.5 cm and its height is reduced to 25.0 cm by virtue of the curvature. However, the precise amount of curvature may be adjusted to account for the desired extent of 3D effect. The curvature of fresnel lens 103 imparts a visual 3D effect from the display projected from monitor screen. It is believed that this 3D effect results from the alteration of the light waves so they are received by the left and right eyes of a viewer at slightly varied angles. A fresnel lens 103 of any shape may be used, as long as it is curved in 2 preferential axes that are transverse to one another. The curved fresnel may be freestanding in relation to the monitor or other image source, or attached to it (e.g., it may have a top hinge, a frame-like enclosure, or some other method of attachment.)

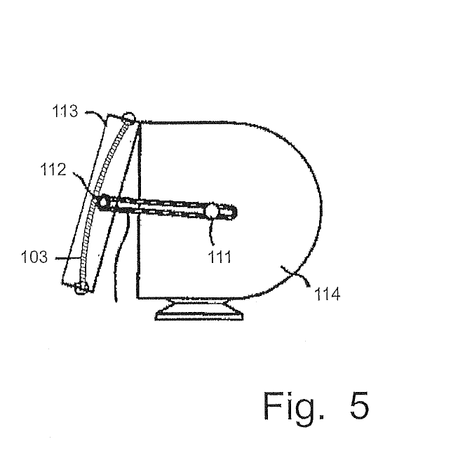

Referring to FIG. 5 herein there is illustrated a side view of a monitor with a pivotal bracket supporting a screen framework, which together comprise a structure attaching the fresnel lens to a housing containing a visual display projection system. The shown configuration utilizes bracket 116, monitor locking knob 111 and screen framework locking knob 112 to be easily adjust the angular disposition of fresnel lens 103 relative to the projected visual display from monitor display screen 102.

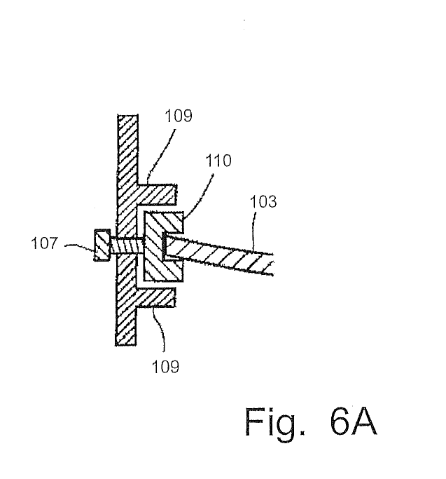

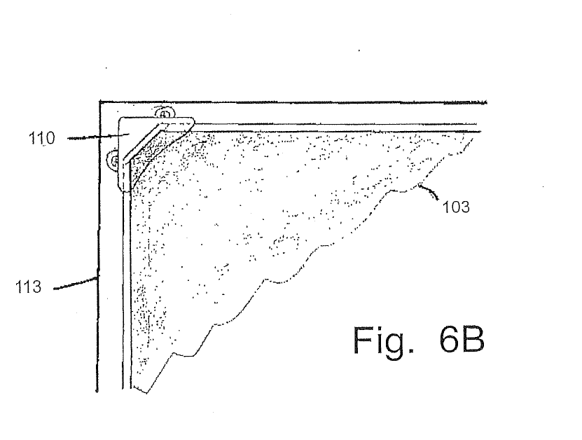

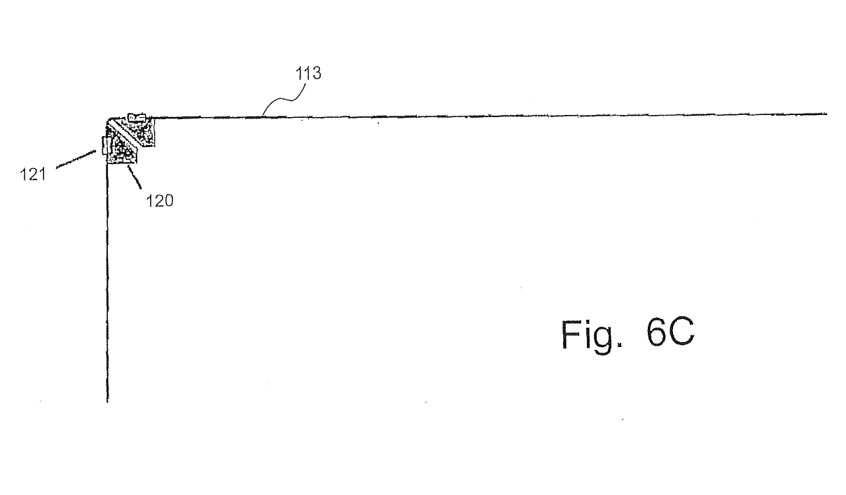

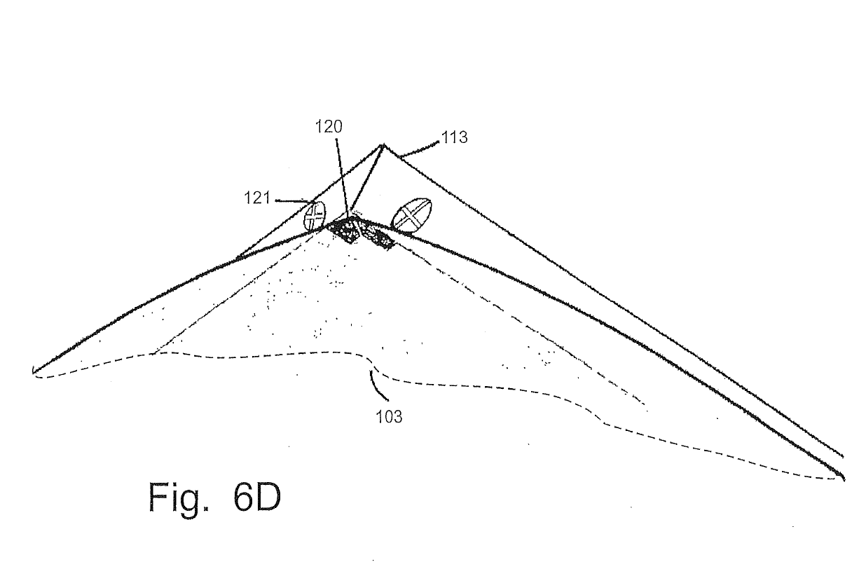

Referring to FIG. 6 there is illustrated a top section view showing the engagement of fresnel lens 103 within a mechanism for tuning the curvature of the fresnel lens 103. As noted above, it may be desirable to adjust the amount of curvature of fresnel lens 103 to achieve the optimal 3D enhancement for a particular viewer or monitor configuration. In one embodiment of the invention this can be accomplished by removing the four corners of fresnel lens 103 by cutting them off transverse to the diagonal approximately 1 cm from each of the four corners, and inserting the resulting straight edges at each corner into four fresnel lens securement frames 110 disposed at each corner of the monitor. The fresnel lens securement frames could be mounted in fresnel lens channels 109 to allow fresnel lens securement frames to move outward, toward the corners of the monitor housing 101, or inward, toward the central area of the monitor, by turning fresnel lens tuning knobs 107, which are threaded securely into monitor housing 101. Those skilled in the art will appreciate that because, as shown in FIGS. 1, 5 and 7 herein there are tuning knobs 107 on each corner of the monitor housing, that the tension applied to one portion of fresnel lens 103 may be different than the tension applied to another portion of fresnel lens 103. This allows the optical qualities of the system to be tuned to appropriately coordinate the precise angle of inclination of fresnel lens 103 with respect to monitor display screen 102. In all cases the curvature of fresnel lens 103 must be more concave than the surface of the monitor display screen 102.

Referring to FIG. 6B herein there is illustrated one embodiment of the invention in which the fresnel is fixed in place; this can be accomplished by removing the four corners of fresnel lens 103 by cutting them off transverse to the diagonal approximately 1 cm from each of the four corners, and inserting the resulting straight edges at each corner into four fresnel lens securement frames 110 disposed at each corner of the monitor.

Referring to FIG. 6C herein there is illustrated a rear view illustrating a further embodiment of the present invention in which the corners of the fresnel 103 are held in position by lens securement devices 120 having a protruding fiat ledge, and screws 121 or other similar projections in the frame corners. In this case the fresnel is contained by a frame 113, the inside corners of which contain screws 121 or similar protrusions (for example, 2 at each corner of the frame) and a lens securement device 120 so as to maintain the desired curvature of fresnel 103. In the example given above, a 30 cm×25.5 cm fresnel could be enclosed in a frame that is 29 cm×25.0 cm having bolts or other suitable fasteners to hold the fresnel into the correctly curved position in each of the four corners.

Referring to FIG. 6D herein there is illustrated a perspective view looking into the frame corner from an upward position according to a further embodiment of the present invention in which one corner of fresnel 103 is being held in position by lens securement device 120 and screws 121.

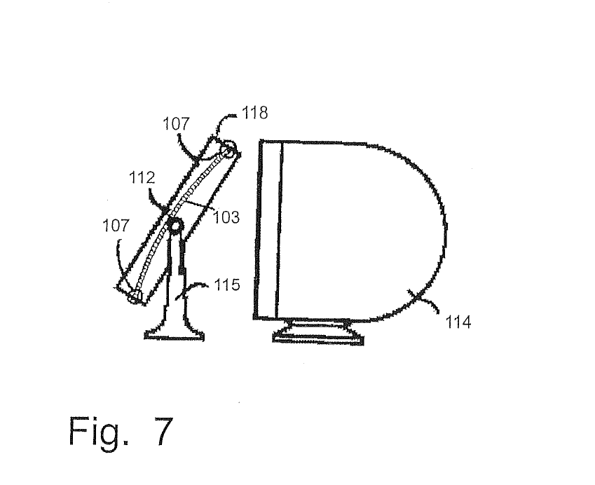

Referring to FIG. 7 herein there is illustrated a specific implementation of the present invention in which the fresnel lens is mounted in a screen framework supported by a base that is detached from the monitor. Base 115 holds screen framework 113 via screen framework locking knob 112, which also provides pivotal adjustment of screen framework with respect to monitor display screen 102.

Those skilled in the art will appreciate that the physical orientation of the image source plus fresnel 103 is variable; for example, it can be placed above the viewer.

Those skilled in the art will appreciate that the present invention herein described may be supplemented with additional optical features. For example, a lenticular array may be positioned between the fresnel lens and the viewer, which would widen the field of view. Additionally, intermediate field variation optics may be positioned between the monitor screen and the fresnel lens, or between the fresnel lens and the viewer, which can also serve to widen the field of view, increase the enhanced depth perception, fold the optical system, alter the size or shape of its “footprint” or space configuration, or have some other desired effect.

It will be appreciated that the present invention may be used individually or severally as a component or components in a more complex optical system.

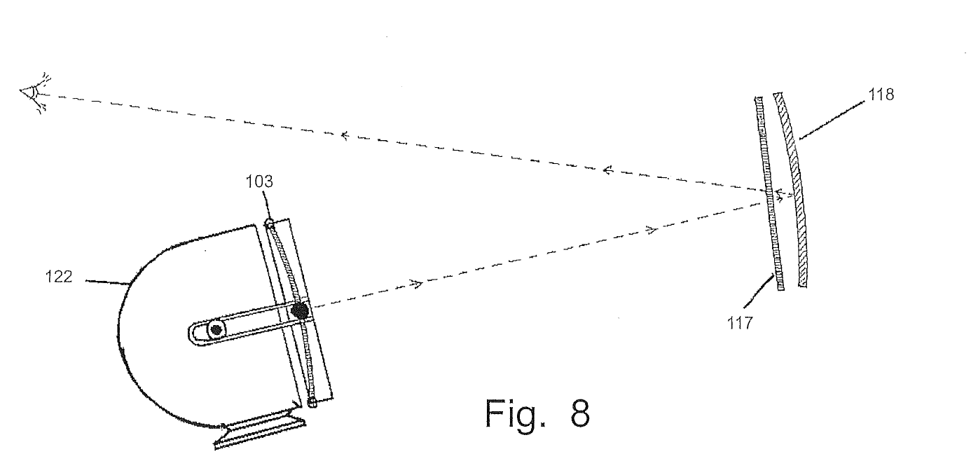

Referring to FIG. 8 herein there is illustrated one embodiment of the present invention in which the curved fresnel lens 103 is combined with an emissive LCD or CRT 122 to project an image onto a second fresnel 117 combined with a concave mirror 118 of appropriate curvature (e.g., spherical or oblate spheroid) which reflects the image towards the viewer.

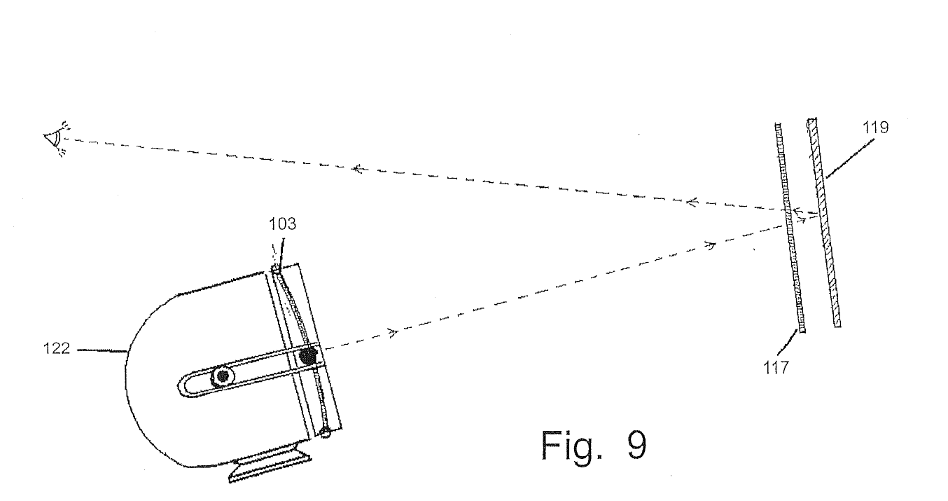

Referring to FIG. 9 herein there is illustrated a further specific implementation of the present invention in which the curved fresnel lens 103 is combined with an emissive LCD or CRT 122 to project an image onto a second fresnel 117 combined with a flat mirror 119 which reflects the image towards the viewer.

Those skilled in the art will also appreciate that two or more of the present invention may be combined to form a more complex projection system and may be combined with other optical elements (e.g., filters, lenses, mirrors or other optical devices).

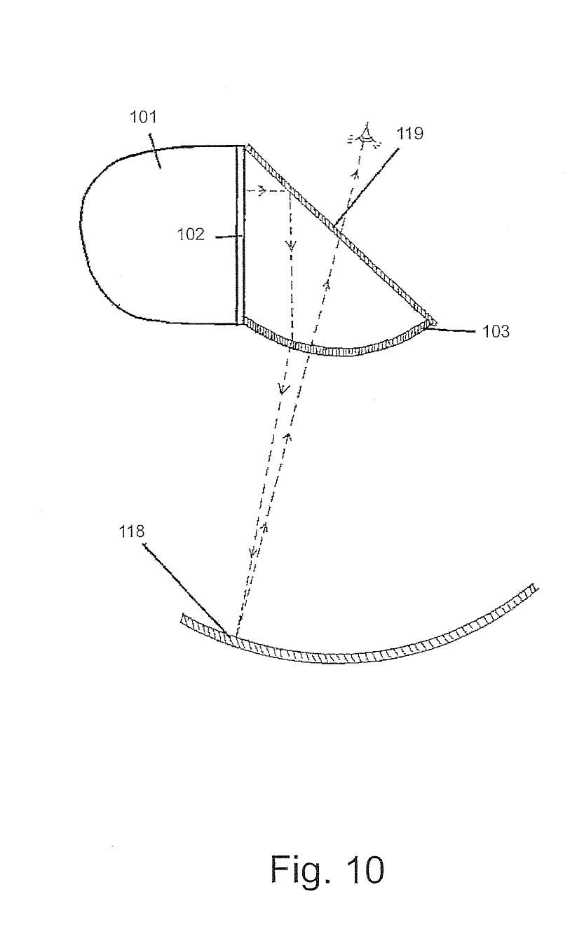

Referring to FIG. 10 herein there is illustrated a schematic view of a folded optical system according to a further specific implementation of the present invention comprising flat mirror 119 and curved mirror 118. In this configuration fresnel lens 103 is positioned substantially at right angles to the 2D image displayed at visual display 102. This configuration uses a “bent” optical system where flat mirror 119 is positioned at a substantially 45° angle to the 2D image and fresnel lens. Such a configuration allows a “bending” or “folding” of the optical system so that the total “footprint” or distance to the viewer is reduced. This particular configuration has the advantage of enhancing the depth of the resulting image, being a virtual 3D image, perceived by the viewer and simultaneously reducing the “footprint” of the total system. Using a spherical (oblate spheroid) mirror produces an image that appears between the spherical mirror and the viewer, at a distance that is determined by the focal length of the mirror. Through utilisation of the curved fresnel lens, the resulting image viewed by the viewer is perceived as having enhanced depth, this being a virtual or simulated 3D image.

As will be apparent to those skilled in the art, the curved fresnel lens is not required to be positioned directly in front of the mirror and may be positioned at a distance from the original image source.

Further specific implementations of the present invention include the use of curved fresnel lens 103 with an optional second fresnel lens, and with a flat mirror or with a curved mirror (e.g., a spherical mirror or oblate spheroid mirror).

Where the system comprises a 2D image together with a curved fresnel lens with the resulting image being projected onto a flat fresnel lens and flat mirror (the lensed side of the distal fresnel lens facing the flat mirror), the resulting final simulated 3D image will appear to pop forward. As will be appreciated by those skilled in the art, in different configurations involving the use of further fresnel lenses and one or more mirrors, athe resulting image may be produced which appears to pop back, as perceived by the viewer.

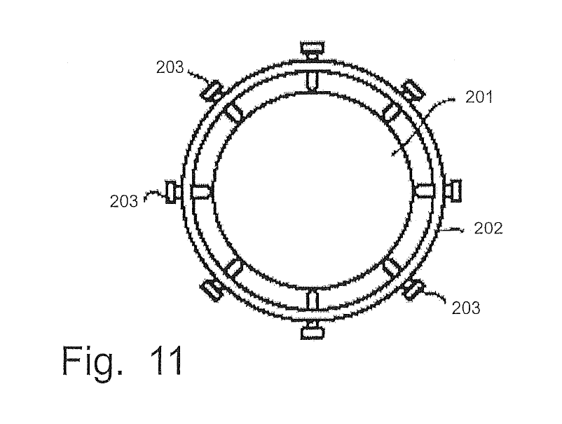

Referring to FIG. 11 herein there is illustrated optical element 201 which may be, for example, a lens (including a fresnel lens), mirror, other any other similar device. Optical element 201 has an outer edge and central portion, where the outer edge is engaged by a plurality of tensioning members (eight shown in this example). Tensioning members are threadably mounted in rigid frame 202. As tensioning members 203 are threaded into or out of frame, they exert a varying tensioning force of optical element 201. This tensioning force deflects the curvature of optical element 201, allowing its optical characteristics to be adjusted. Those skilled in the art will appreciate that the amount of tension exerted by the tensioning members may vary; in other words, it is not required that all tensioning members exert an identical amount of force on optical element 201. This variation in forces can cause one area of optical element 201 to have different light transmissive or reflective properties than other areas of optical element 201. This allows optical element to be 201 to be tuned to create the desired optical effect, or to counteract optical aberrations in other portions of the system in which optical element 201 is used.

Those skilled in the art will appreciate that the present invention herein described may be supplemented with additional optical features. For example, a lenticular array may be positioned between the fresnel lens and the viewer, which would widen the field of view. Additionally, intermediate field variation optics may be positioned between the monitor screen and the fresnel lens which can also serve to widen the field of view.

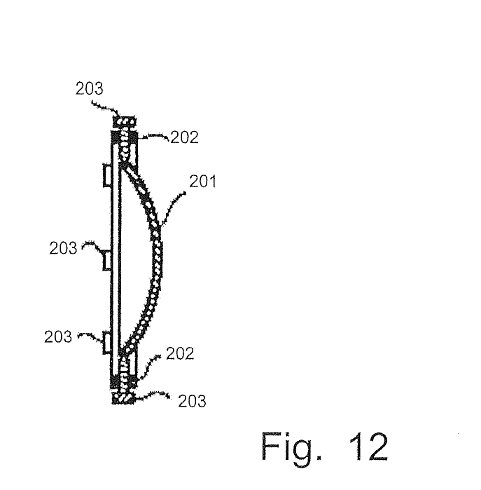

Referring to FIG. 12 herein there is illustrated a side sectional view of FIG. 10 herein. From this view, it may be appreciated that optical element is curved, having a generally convex configuration. As tensioning members 203 are screwed inward toward the central portion of optical element 201, they will cause optical element 201 to increase its curvature, which, in turn, alters its optical properties. FIG. 12 also shows how tensioning members 203 are held by rigid ring 202.

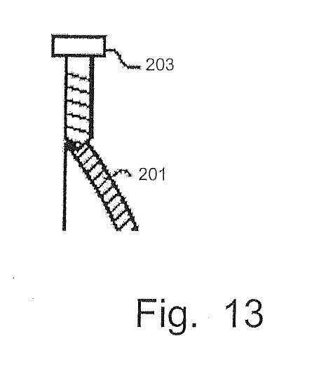

Referring to FIG. 13 there is illustrated a cross sectional view showing one variety of engagement between tensioning member 203 and optical element 201. In this embodiment, optical element 201 has a V-shaped groove along its outer edge, which engages the tip of tensioning member 203.

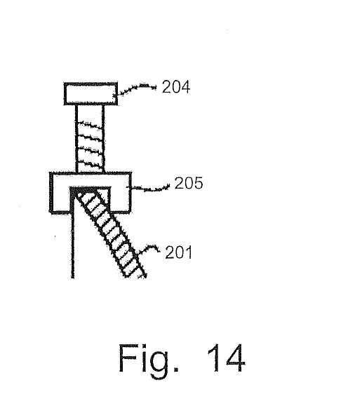

Referring to FIG. 14 there is illustrated an alternate embodiment for engaging tensioning member 204 with optical element 201, in which tensioning member 204 is fitted with saddle 205.

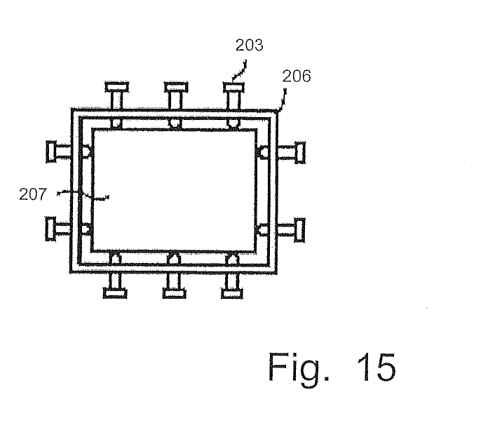

Referring to FIG. 15 there is illustrated an embodiment of the invention utilizing rectangular optical element 207. Again, rigid frame 206 supports a plurality of tensioning members 203.

1. A system for producing a simulated 3D image from a 2D image, said system comprising: a fresnel lens comprising at least two axes of curvature, said at least two axes of curvature being transverse to one another; wherein said fresnel lens is orientated relative to said 2D image to produce a simulated 3D image having enhanced depth, and wherein a lensed surface of said fresnel lens is orientated relative to said visual display wherein light waves from said 2D image are incident at said lensed surface of said fresnel lens, the refracted light waves being received at a viewer as an image of said 2D image having enhanced depth.

2. The system as claimed in claim 1 wherein light waves refracted by said fresnel lens are received by a left and right eye of a viewer at slightly varied angles.

3. The system as claimed in claim 2, wherein said fresnel lens is flexible, said system further comprising: a frame configured for mounting said fresnel lens; and a plurality of adjustable engagers, said adjustable engagers being positively adjustable through said frame each engager of said plurality of engagers being configured for an independent engaging of a portion of an outer edge of said fresnel lens; wherein an engaging of said outer edge by each said engager is adjustable to provide a flexing of said fresnel lens and a change in optical properties of said fresnel lens.

4. The system as claimed in any preceding claim further comprising a reflective surface configured for reflecting light waves received from said fresnel lens to a viewer.

5. A method of producing a simulated 3D image of a real object or a substantially 2D image comprising: refracting light waves from an object or from a 2D image through a curved fresnel lens having a smooth surface and a lensed surface; wherein said fresnel lens is configured to generate a simulated 3D image of said object or said 2D image and wherein said fresnel lens is curved in two planes.

6. The method as claimed in claim 5 further comprising: adjustably mounting said fresnel lens within a frame using a plurality of adjustable tensioning engagers; adjusting each engager so as to engage a portion of an outer edge or corner of said fresnel lens; adjusting the curvature of said fresnel lens by adjustment of at least one engager of said plurality of engagers wherein at least one optical characteristic of said fresnel lens is altered.

7. A method of enhancing the image from a projected visual display comprising the steps of: passing the projected visual display through a fresnel lens having a smooth side and a lensed side, wherein the fresnel lens is positioned so that the lensed side faces the projected display, and wherein the fresnel lens is curved along a first plane, and a second plane with respect to the projected visual display.

8. A tunable optical system comprising: a flexible optical element having an outer edge; a frame configured for mounting said optical element; a plurality of adjustable engagers being positively adjustable through said frame, each engager of said plurality of engagers being configured for an independent engaging of a portion of said outer edge of said optical element; wherein an engaging of said outer edge by each engager is adjustable to provide a flexing of said optical element and a change in optical properties of said optical element, wherein said optical element comprises a fresnel lens for generating a simulated 3D image from a 2D image, and said fresnel lens comprises a smooth surface and a lensed surface, said fresnel lens being orientated such that said lensed surface faces said 2D image, and wherein said frame is a rigid frame, said engagers being configured to exert a varying tensioning force on said optical element so as to alter the curvature of the optical element providing adjustment of said optical characteristics of said optical element, and each engager is configured to be screwed inward and outward relative to a central portion of said optical element, and each engager is configured for engaging directly onto an outer edge of said optical element.
